(19) United States
(12) Patent Application Publication
(10) Pub. No.: US 2025/0262876 A1
(43) Pub. Date: Aug. 21, 2025

(54) RECORDING DEVICE AND METHOD OF CONTROLLING CARRIAGE

(71) Applicant: SEIKO EPSON CORPORATION, Tokyo (JP)

(72) Inventors: Norihito SUGAYA, SHIOJIRI-SHI (JP); Yusuke TANIGUCHI, SHIOJIRI-SHI (JP); Ryuji MORIYAMA, MATSUMOTO-SHI (JP)

(21) Appl. No.: 19/056,981

(22) Filed: Feb. 19, 2025

(30) Foreign Application Priority Data
Feb. 20, 2024 (JP) 2024-023555

(51) Int. Cl. B41J 25/00; B41J 11/00

(52) U.S. Cl. CPC B41J 25/005; B41J 11/00212; B41J 11/00214

(57) ABSTRACT

A recording device includes a carriage in which a recording head and a light source are mounted. The carriage is configured to reciprocate in a main scanning direction. The recording head is configured to eject photocurable ink to a medium. The light source is configured to emit light that causes the photocurable ink ejected in an outward operation to be cured. The recording device also includes a control unit configured to control an operation of the carriage. In the recording device, the control unit determines a movement range in step S140 so as to turn from the outward operation to a returning operation at a position at which an area irradiated with light by the light source does not deviate from a region of the medium where the photocurable ink is ejected, and controls movement of the carriage.

The present application is based on, and claims priority from JP Application Serial Number 2024-023555, filed on Feb. 20, 2024, the disclosure of which is hereby incorporated by reference herein in its entirety.

### BACKGROUND

### 1. Technical Field

The present disclosure relates to a recording device and a method of controlling a carriage, and in particular, relates to a recording device and a method of controlling a carriage that are configured to perform recording using photocurable ink.

### 2. Related Art

JP-A-2006-26970 discloses a recording device configured to perform recording using photocurable ink.

JP-A-2006-26970 discloses an ink-jet recording device including a recording head 4 configured to eject photocurable ink on the recording medium, and a light source 5. The ink-jet recording device further includes a carriage 3 configured to be able to reciprocate in a main scanning direction. In this ink-jet recording device, the recording head 4 ejects the photocurable ink while the carriage 3 is moving in the outward direction, and the light source 5 emits curing light onto the photocurable ink.

After the area irradiated with light beam emitted from the light source 5 overpasses the recording medium, the carriage 3 turns back to operate in the returning direction. In this manner, the light source 5 moves in the outward direction until overpassing the recording medium. This makes it possible to reliably fix and cure the photocurable ink ejected by the recording head 4.

In a case of a typical ink-jet recording device, the light source of the carriage always moves until it overpasses the recording medium, in order to reliably cure the photocurable ink in the outward operation. This leads to an increase in the movement distance of the carriage in the main scanning direction, which makes it difficult to improve the throughput.

### SUMMARY

The present disclosure provides a recording device including a carriage in which a recording head and a light source are mounted, the carriage being configured to reciprocate in a main scanning direction, the recording head being configured to eject photocurable ink to a medium, the light source being configured to emit light that causes the photocurable ink ejected in an outward operation to be cured, and a control unit configured to control an operation of the carriage, in which the control unit controls movement of the carriage so as to turn from the outward operation to a returning operation at a position at which an area irradiated with light by the light source does not deviate from a region of the medium where the photocurable ink is ejected.

In addition, the present disclosure provides a method of controlling a carriage of a recording device configured to control an operation of a carriage configured to reciprocate in a main scanning direction, the carriage being a carriage in which a recording head and a light source are mounted, the recording head being configured to eject photocurable ink to a medium, the light source being configured to emit light that causes the photocurable ink ejected in an outward operation to be cured, the method including acquiring a region of the medium where the photocurable ink is ejected, determining a turning position from the outward operation to a returning operation at a position at which an area irradiated with light by the light source does not deviate from a region where the photocurable ink is ejected, and controlling movement of the carriage at the turning position.

### BRIEF DESCRIPTION OF THE DRAWINGS

FIG. 1 is a block diagram schematically illustrating an ink-jet recording device to which a recording device according to the present disclosure is applied.

FIG. 2 is a schematic view illustrating arrangement of a recording head and a light source mounted at a carriage.

FIG. 3 is a flowchart concerning a program used to control an operation of the carriage.

FIG. 4 is a diagram illustrating a process of moving the carriage.

FIG. 5 is a diagram illustrating a process of moving the carriage.

FIG. 6 is a diagram illustrating a process of moving the carriage.

FIG. 7 is a diagram illustrating a distance from the light source of the carriage to a medium and a movement range of the carriage.

FIG. 8 is a diagram illustrating a distance from the light source of the carriage to a medium and a movement range of the carriage.

FIG. 9 is a diagram illustrating a table for reference concerning the movement range of the carriage on the basis of the distance from the light source of the carriage to the medium.

FIG. 10 is a flowchart concerning a program according to a modification example of controlling of an operation of the carriage.

### DESCRIPTION OF EMBODIMENTS

Below, embodiment according to the present disclosure will be described with reference to the drawings.

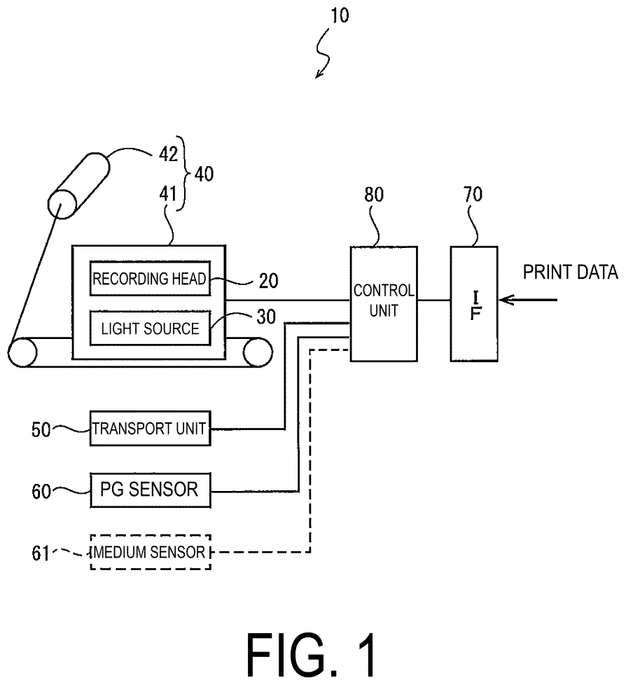

FIG. 1 is a block diagram schematically illustrating an ink-jet recording device to which a recording device according to the present disclosure is applied.

This recording device 10 includes: a recording head 20; a carriage unit 40 on which a light source 30 is mounted, the carriage unit 40 being configured to reciprocate in a main scanning direction; a transport unit 50 configured to transport a medium in a direction substantially perpendicular to the main scanning direction; a PG sensor 60; and a control unit 80 configured to receive print data through an interface unit 70 to control printing.

The recording head 20 is controlled by the control unit 80, and is configured to eject photocurable ink to a medium transported by the transport unit 50. The carriage unit 40 includes a carriage 41 on which the recording head 20 and the light source 30 are mounted in this order from the destination side at the time of outward movement toward the rearward side. The carriage unit 40 is driven by a driving unit 42 to reciprocate along a predetermined guide. The light source 30 emits light used to cure photocurable ink ejected from the preceding recording head 20 at the time of outward movement. The control unit 80 causes the transport unit 50 to move a medium in a sub scanning direction, and at the same time, controls ejection of the photocurable ink by the recording head 20 and fixing by the light source 30 while controlling an outward operation and a returning operation of the carriage unit 40.

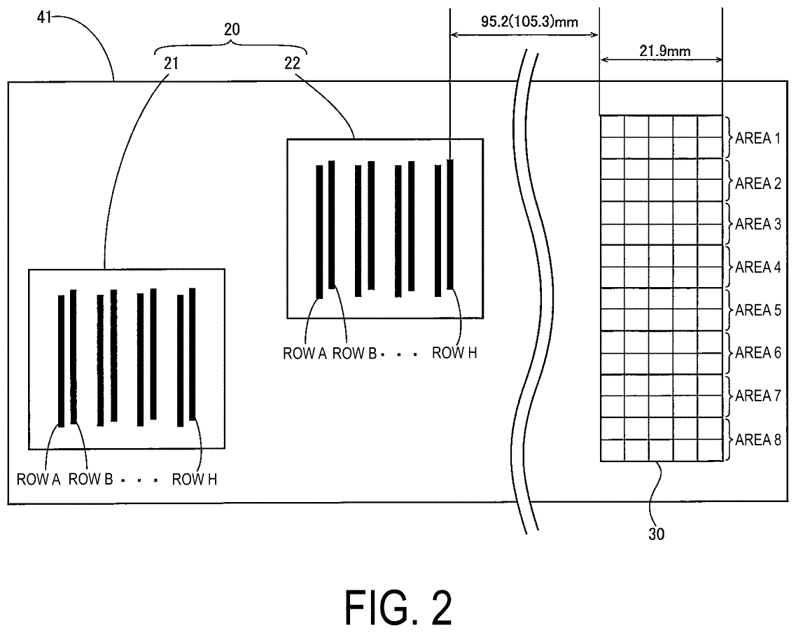

FIG. 2 is a schematic view illustrating arrangement of the recording head and the light source mounted at the carriage.

A head 21 and a head 22 as the recording head 20 are mounted at this carriage 41. In the heads 21 and 22, a nozzle row A to a nozzle row H each including 180 pieces of nozzles extending in parallel to the sub scanning direction are arrayed in parallel to the main scanning direction. The head 21 is disposed upstream of the head 22 in the sub scanning direction.

In addition, the head 21 is disposed downstream of the head 22 in the main scanning direction. The “downstream in the main scanning direction” represents the destination side at the time of outward movement.

The light source 30 is disposed downstream of the heads 21 and 22 in the main scanning direction, and has a length that makes it possible to cover all the nozzles of the head 22 and the head 21 disposed so as to be positionally shifted from each other in the sub scanning direction. The light source 30 is divided into an area 1 to an area 8 in the length direction, and is also divided into five areas in the width direction. One LED configured to emit ultraviolet light is disposed for each of the divisions.

The distance from the H column of the head 22 to the light source 30 is 95.2 mm in a case of the recording device 10 of an A3 model device. Note that the recording device 10 of an A4 model device only includes one head, and the distance from the light source 30 to the H column that is the nearest to the light source 30 is 105.3 mm. LEDs of the light source 30 are arrayed in two stages and five columns in each of the areas. Each of the LEDs has a size of 3.5 mm×3.5 mm in length and width. The interval in the sub scanning direction (longitudinal direction) is 0.9 mm, and the interval in the main scanning direction (width direction) is 1.1 mm. Thus, the width of each of the areas is 21.9 mm.

At the time of the outward operation, a predetermined nozzle of the head 21, 22 ejects photocurable ink. Once the photocurable ink is attached on the medium, the photocurable ink is irradiated with ultraviolet light emitted from the LED of the light source 30 disposed downstream in the main scanning direction, and is fixed. The movement distance until all the LEDs of five columns of the light source 30 face the photocurable ink ejected from the nozzle in the H column of the head 22 disposed most downstream in the main scanning direction is 117.1 mm obtained by adding 21.9 mm that is the length of five columns of LEDs serving as the light source 30, to 95.2 mm that is the distance from the H column to the light source. In other words, when the carriage 41 is further moved by 117.1 mm after the photocurable ink is ejected by the H column of nozzles, all the LEDs of the five columns of the light source 30 emit the light onto the photocurable ink.

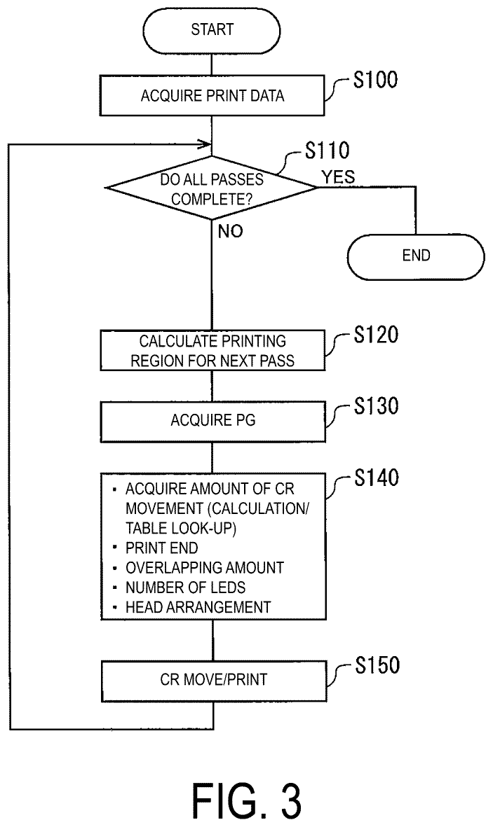

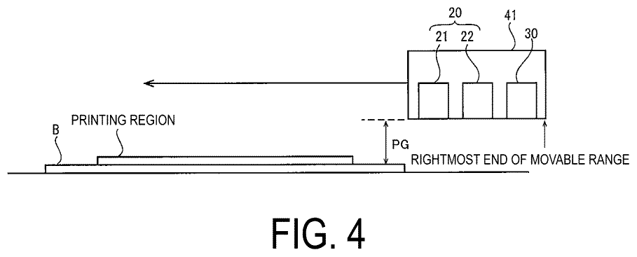

FIG. 3 illustrates a flowchart concerning a program for controlling the operation of the carriage. FIGS. 4 to 6 each illustrate a diagram illustrating a process of moving the carriage.

The control unit 80 performs control in accordance with the flowchart shown in FIG. 3. First, in step S100, the control unit 80 acquires print data. After acquiring the print data, the control unit 80 generates control data for each pass that is used to cause the carriage 41 to reciprocate to proceed printing. Then, in step S110, processes of step S120 and thereafter are repeated until it is determined that printing for all passes ends.

In step 120, the control unit 80 calculates a printing region for the next pass. This printing region represents a region in which, when a starting position for the carriage 41 is set at the rightmost end of the movable range as illustrated in FIG. 4, the carriage 41 moves toward the left direction in the outward path, and the recording head 20 ends ejecting the photocurable ink. Next, in step S130, the control unit 80 acquires a platen gap PG from the PG sensor 60.

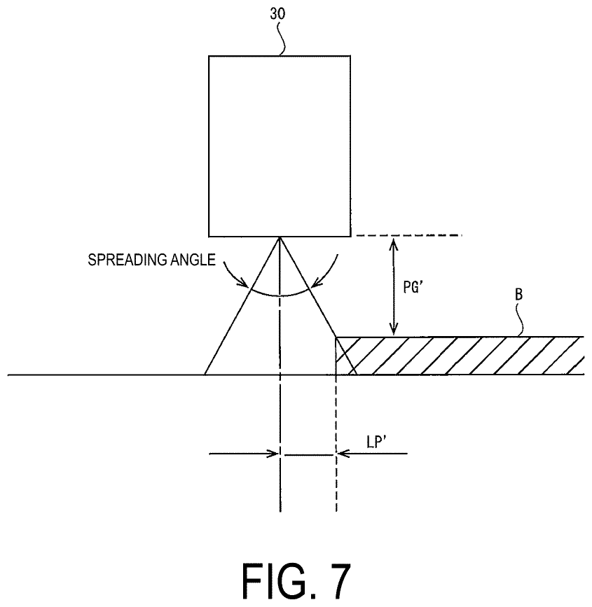

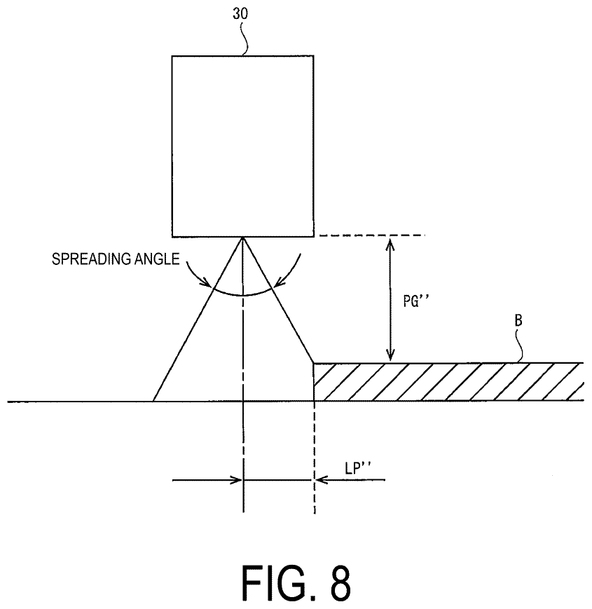

FIGS. 7 and 8 each illustrate a movement range of the carriage and a distance from the light source of the carriage to a medium.

The platen gap PG represents a distance between the recording head 20 and the medium B. This recording device 10 is configured such that the distances from the medium to the heads 21 and 22 of the recording head 20, and to the light source 30 are all equal. That is, the distance from the light source 30 to the medium is the platen gap PG. The recording ink ejected from the nozzles of the heads 21 and 22 lands on the medium at a velocity and in a direction indicated by a composite vector made out of a movement component of the outward direction of the carriage 41 and a movement component of an ejection direction in which the ink is ejected from the nozzle. In addition, the ultraviolet light emitted from each of the LEDs of the light source 30 has a predetermined spreading angle. For example, in a case of a platen gap PG′ illustrated in FIG. 7, the center of the light source 30 needs to move to a position of a distance LP′ from the end of the medium B in order for the irradiated area to overpass the end portion of the medium B. In contrast, in a case of a platen gap PG″ illustrated in FIG. 8, the center of the light source 30 needs to move to a position of a distance LP″ from the end of the medium B in order for the irradiated area to overpass the end portion of the medium B. That is, the amount of movement of the carriage 41 in the main scanning direction is smaller in the turning position in a case where the platen gap PG is small.

In this manner, in a case where the platen gap PG exists, the distance of movement (from the end portion of the medium B) of the light source 30 that is necessary to irradiate the end portion of the medium B changes depending on the platen gap PG. This relationship can be mutually obtained through calculation on the basis of the spreading angle from the light source 30 as illustrated in the drawing or the platen gap PG. Note that, as described later, the platen gap is used as one of parameters in calculating the turning position. This distance LP is referred to as an adjustment amount. This means that, even when the light source 30 is disposed at a position that does not overpass the predetermined position of the medium, it is possible to emit ultraviolet light to the range downstream by this distance LP.

In step S140, the control unit 80 acquires the necessary amount of movement of the carriage 41. Information necessary to acquire this amount of movement includes the position of the printing end on the basis of the printing region calculated in step S120, the overlapping amount that is the width of the light source 30 and overlaps with the inner side of the printing region than the end portion of the printing region with this end portion being the reference, the size of and the number of LEDs mounted on the carriage 41, and the arrangement positions of the heads 21 and 22.

Calculation is performed in the following manner, as a specific example.

The most downstream nozzle that ejects photocurable ink exists in the H column of the head 22. The distance from this position to the light source 30 is 95.2 mm in a case of the A3 model device, and the width of all the LEDs of the light source 30 is 21.9 mm. It is known that, in a certain environment, fixing can be sufficiently achieved even if the last photocurable ink is not irradiated with the emitted light of all the LEDs. In a case of the light source 30 of the present example, the irradiated area of the four LEDs is sufficient for the last photocurable ink. This means that, by leaving an overlapping amount OW having the width of one LED, the carriage 41 is allowed to turn to the returning operation from the outward operation.

Absence of overlapping amount means that the area irradiated with the light by the light source 30 deviates from a region of the medium B where the photocurable ink is ejected, and the printing region and the light source 30 do not overlap with each other. In addition, existence of the overlapping amount means that movement of the carriage 41 is controlled such that the outward operation is performed to a position at which the area irradiated with light by the light source 30 does not deviate from the region of the medium B where the photocurable ink is ejected, and then, operation is turned to the returning operation. However, the distance LP that is the adjustment amount based on the spreading angle of the light source 30 and the platen gap PG is reflected at the end, as described above.

In this manner, with the end portion of the printing region being the base point, returning is performed at a position at which the overlapping amount OW of one LED is subtracted from the movement distance obtained by adding the width of the light source 30 to the position where the nozzle row H of the head 22 is disposed.

In addition, the overlapping amount OW changes depending on the fixing situation, and it is possible to perform adjustment in a unit of the number of LEDs. That is, it is possible to adjust the turning position concerning a unit of the number of LEDs. By increasing the overlap OW, it is possible to reduce the movement range of the carriage 41, which makes it possible to improve the throughput.

In this manner, when the light source 30 includes light elements of a plurality of columns in the scanning direction, the control unit 80 adjusts the turning position in a unit the width of the light elements.

In step S150, the control unit 80 causes printing to be performed while moving the carriage 41 so as to achieve the movement distance described above.

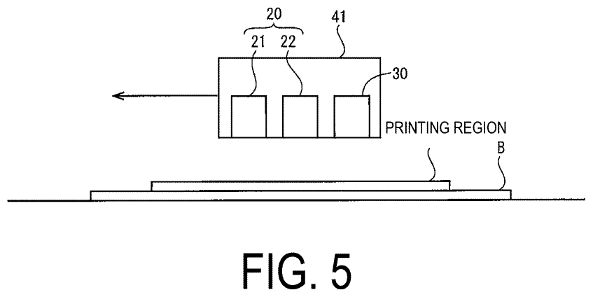

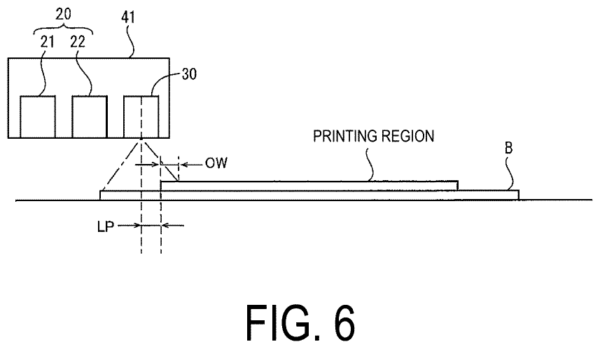

With reference to the drawing, the rightmost end of the movable range of the carriage 41 illustrated in FIG. 4 is first moved to the starting position, and is started from this position. During the operation, predetermined photocurable ink is ejected from the heads 21 and 22 of the recording head 20 while the carriage 41 is being moved on the basis of the control data regarding the current printing pass based on the print data as illustrated in FIG. 5. Then, the light source 30 emits, to the ink, ultraviolet light for fixing. FIG. 6 illustrates a state where the carriage 41 moves by the necessary amount of movement calculated in step S140, and at this position, the carriage 41 is turned from the outward operation to the returning operation.

The position of turning is a position at which, by setting the overlapping amount OW as described above, the area irradiated with light by the light source 30 does not deviate from the region of the medium B where the photocurable ink is ejected. After the outward operation is performed to this position, the operation is turn to the returning operation.

When this turning position is specified, the control unit 80 makes change on the basis of the platen gap PG that is the distance between the light source 30 and the medium B, as described above. This is because the emitted light from the light source 30 spreads out, and the irradiated area changes depending on the distance to the medium B.

This eliminates the need of always moving the carriage 41 such that the light source 30 overpasses the end of the medium B as in the related art. This makes it possible to achieve both curing the photocurable ink and improvement in the throughput.

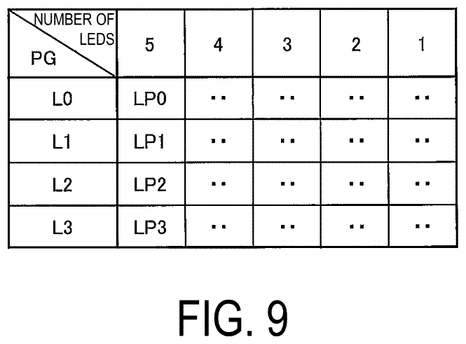

FIG. 9 is a diagram illustrating a table for reference concerning the movement range of the carriage on the basis of the distance from the light source of the carriage to the medium.

In order to obtain the amount LP of movement of the adjustment amount on the basis of the platen gap PG, it may be possible to make calculation every time. However, it may be possible to obtain it by looking up the table illustrated in FIG. 9. As for this table, by looking up the table on the basis of two parameters of the platen gap PG and the number of LEDS so as to perform adjustment using the number of LEDs in accordance with the fixing situation at the same time, it is possible to look at the amount LP of movement of the adjustment amount. In this manner, the control unit 80 uses the distance between the light source 30 and the medium B as a parameter to look up a predetermined table, thereby determining the turning position described above.

Note that, as for a method of controlling a carriage of the recording device 10, step S120 corresponds to a step of acquiring a region of the medium B where photocurable ink is ejected; step S130 and step S140 correspond to a step of determining the turning position from the outward operation to the returning operation at a position at which the area irradiated with light by the light source 30 does not deviate from the region where the photocurable ink is ejected; and step S150 corresponds to a step of controlling movement of the carriage 41 at the turning position.

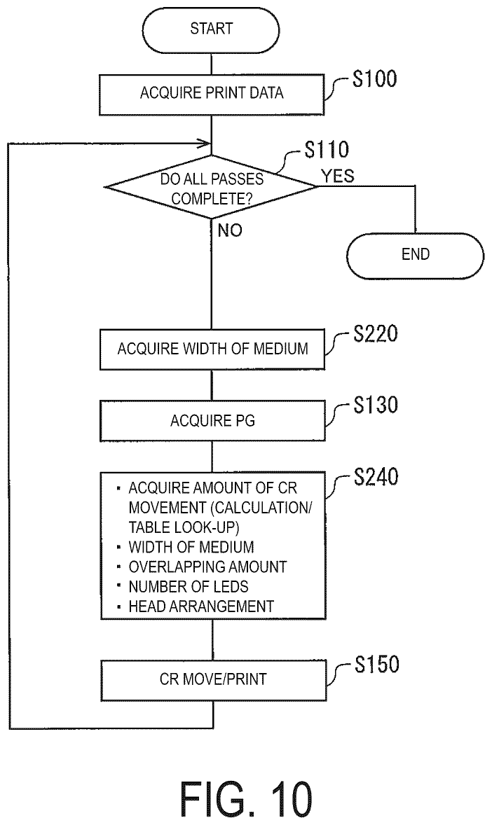

FIG. 10 is a flowchart concerning a program according to a modification example of controlling of an operation of the carriage.

In the embodiment described above, the movement range of the carriage 41 is obtained with the reference being the end of the printing region where the photocurable ink is actually ejected. However, it is possible to use the end of the printing medium B as the reference similarly to the printing region. Even in this case, by determining the overlapping amount OW and returning the operation at this position, it is possible to make the turning position earlier than the related art, which contributes to an improvement in the throughput.

Differences from the flowchart shown in FIG. 3 lie in that the control unit 80 performs a process of acquiring the width of the medium in step S220 in place of step S120, and the control unit 80 uses this width of the medium as a reference in place of the printing region to acquire the amount of movement in step S240 in placed of step S140. Note that, as indicated by the dashed line in FIG. 1, a medium sensor 61 is provided, and the output from the medium sensor 61 is obtained to acquire the width of the medium in step S220.

Furthermore, as in the previous embodiment, turning is performed in a range from the position that does not deviate from the printing region to the position that does not deviate from the printing medium as in this modification example. This makes it possible to improve the throughput as compared with the related art.

In addition, the recording device 10 may include an adjustment mechanism configured to adjust the platen gap PG. For example, the adjustment mechanism includes a moving unit configured to move the recording head 20 to adjust the gap to the medium B, or a moving unit configured to move the position of a support portion configured to support the medium B, or the like.

Note that it is needless to say that the present disclosure is not limited to the embodiment described above. It is obvious for those skilled in the art that:
mutually replaceable members, configurations, and the like disclosed in the embodiment described above can be applied by appropriately changing their combinations;
although not disclosed in the embodiment, known members, known configurations, and the like that are mutually replaceable with the members, configurations, and the like disclosed in the embodiment are appropriately replaced, and also combinations thereof are changed and applied; and
although not disclosed in the embodiment, the members, the configurations, and the like disclosed in the embodiment described above are appropriately replaced, as a replacement, with members, configurations, and the like that those skilled in the art could conceive on the basis of know techniques or the like, and also combinations thereof are changed and applied. These should be disclosed as embodiments of the present disclosure.

What is claimed is:

1. A recording device comprising:
a carriage in which a recording head and a light source are mounted, the carriage being configured to reciprocate in a main scanning direction, the recording head being configured to eject photocurable ink to a medium, the light source being configured to emit light that causes the photocurable ink ejected in an outward operation to be cured; and
a control unit configured to control an operation of the carriage, wherein
the control unit controls movement of the carriage so as to turn from the outward operation to a returning operation at a position at which an area irradiated with light by the light source does not deviate from a region of the medium where the photocurable ink is ejected.

2. The recording device according to claim 1, wherein
the control unit changes a turning position on a basis of a distance between the light source and the medium.

3. The recording device according to claim 2, wherein
the control unit calculates the turning position using, as a parameter, a distance between the light source and the medium.

4. The recording device according to claim 2, wherein
the control unit looks up a predetermined table using a distance between the light source and the medium as a parameter to determine the turning position.

5. The recording device according to claim 1, wherein
the control unit is configured to adjust a turning position.

6. The recording device according to claim 5, wherein
the light source includes a light element of a plurality of columns in a scanning direction, and
the control unit adjusts the turning position in a unit of a width of the light element.

7. A method of controlling a carriage of a recording device configured to control an operation of a carriage configured to reciprocate in a main scanning direction, the carriage being a carriage in which a recording head and a light source are mounted, the recording head being configured to eject photocurable ink to a medium, the light source being configured to emit light that causes the photocurable ink ejected in an outward operation to be cured, the method including:
acquiring a region of the medium where the photocurable ink is ejected;
determining a turning position from the outward operation to a returning operation at a position at which an area irradiated with light by the light source does not deviate from a region where the photocurable ink is ejected; and
controlling movement of the carriage at the turning position.
